(19) United States
(12) Patent Application Publication
(10) Pub. No.: US 2007/0227964 A1
(43) Pub. Date: Oct. 4, 2007

(54) Fluid filter element and bypass insert

(75) Inventors: Walter J. Fick, Kearney, NE (US); Thomas C. Richmond, Kearney, NE (US); James N. Marshall, Elm Creek, NE (US)

Correspondence Address: REINHART BOERNER VAN DEUREN P.C., 2215 PERRYGREEN WAY, ROCKFORD, IL, 61107, US

(73) Assignee: Baldwin Filters, Inc., Kearney, NE (US)

(21) Appl. No.: 11/394,676

(22) Filed: Mar. 31, 2006

(51) Int. Cl. B01D 27/00

(52) U.S. Cl. 210/450; 210/451; 210/455

(57) ABSTRACT

An improved fluid filter arrangement having an improved fluid bypass is provided. The fluid filter arrangement includes a ring of filter media extending between first and second ends sealingly bonded to first and second end caps, respectively. The filter media defines an interior. Each end cap includes an opening in fluid communication with the interior. A grommet comprising at least in part a sealing material that is different than the material for the second end cap is received by the opening in the second end cap. The grommet is sealed against the second end cap. Furthermore, the grommet includes an annular-flange which includes an annular valve seat and a fluid bypass opening.

### FIELD OF THE INVENTION

This invention generally relates to a fluid filter, more particularly, this invention relates to a fluid filter that includes a fluid bypass which allows fluid to bypass the filter media.

### BACKGROUND OF THE INVENTION

Fluid filters incorporating a fluid bypass are well known in the art. Typically, the bypass includes a pressure relief valve that opens upon excess pressure build up. The bypass acts to allow dirty fluid to short-circuit the filter element of the filter when the filter element becomes clogged with contaminants. Although it is not typically preferred to allow dirty fluid to flow through the filter without being filtered, it is more preferable than preventing a sufficient amount of fluid such as lubricating oil to flow through the system which can result in catastrophic engine failures.

An example of such a fluid filter is disclosed in U.S. Pat. No. 5,770,054 to Wilhelm Ardes. The '054 patent to Ardes includes a filter element with an upper plastic end cap providing a bypass valve seat that seats against a valve on a standpipe in a housing. The filter element also includes a lower plastic end cap that carries a separate felt gasket. Due to end cap alignment issues and material issues, there are concerns about reliability of sealing, particularly at the valve seat formed integrally into the plastic upper end cap. The present invention relates to improvements over Ardes and the current state of the art in fluid filters that incorporate a fluid bypass.

### BRIEF SUMMARY OF THE INVENTION

In one aspect, the invention provides an improved fluid filter arrangement having an improved fluid bypass. The fluid filter arrangement includes a ring of filter media extending between first and second ends sealingly bonded to first and second end caps, respectively. The filter media defines an interior. Each end cap includes an opening in fluid communication with the interior. A grommet comprising at least in part a sealing material that is different (e.g. that may be more resilient and/or more compressible) than the material for the second end cap is received by the opening in the second end cap. The grommet is sealed against the second end cap. Furthermore, the grommet includes an annular flange which includes an annular valve seat or seal and a fluid bypass port therethrough.

In another aspect, the invention provides a cylindrical ring of filter media, first and second end caps secured to the ring of filter media, and a grommet, wherein the cylindrical ring of filter media extends between first and second ends and defines an interior. The first end cap is secured to the first end of the ring of filter media. The first end cap includes a first opening fluidically connected to the interior and includes a seal structure surrounding the first opening configured for engagement with a standpipe. The second end cap is sealingly bonded to the second end of the ring of filter media and includes a second opening. The second end includes snap connection means for releasably securing the second end cap to a housing. The grommet comprises at least in part a sealing material different than said second end cap and is disposed on the second end cap. The grommet further includes means for defining an annular valve seat and means for defining a fluid bypass port therethrough.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a cross-sectional view of an exemplary embodiment of a fluid filter arrangement including a grommet constructed in accordance with the teachings of the present invention;

FIG. 2 is an enlarged partial cross-sectional view of the filter cartridge of FIG. 1 wherein the top end cap sealingly receives a grommet secured thereto in accordance with the present invention;

FIG. 3 is a perspective view of the grommet in FIG. 2;

FIG. 4 is a perspective view of an alternative embodiment of a grommet to that of FIG. 1;

FIG. 5 is a partial cross-sectional view of a filter cartridge having the grommet of FIG. 4 secured to the top end cap of the filter cartridge;

FIG. 6 is a perspective view of an alternative embodiment of a grommet to that of FIG. 1;

FIG. 7 is a perspective view of an alternative embodiment of a grommet to that of FIG. 1;

FIG. 8 is a perspective view of a further alternative embodiment of a grommet to that of FIG. 1;

FIG. 9 is a perspective view of yet another embodiment of a grommet to that of FIG. 1; and

FIG. 10 is a partial cross-sectional view of a filter cartridge and housing lid including the grommet of FIG. 9 secured to a top end cap.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

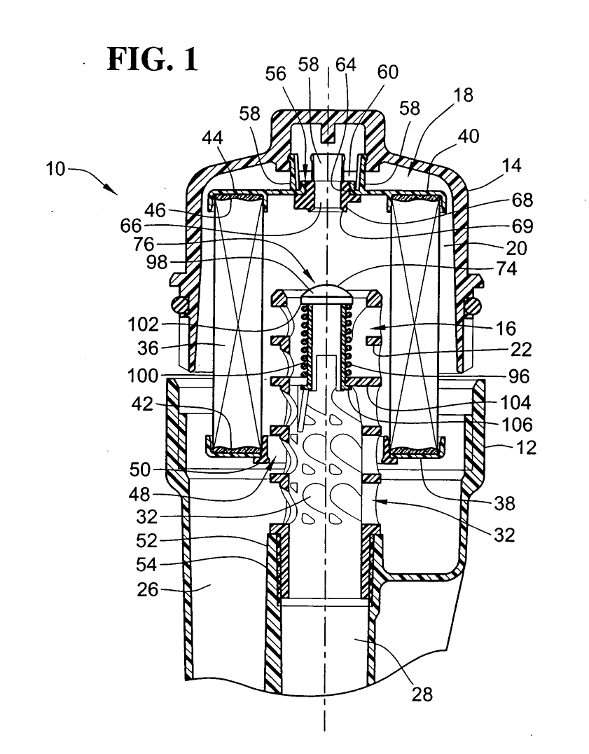

A fluid filter arrangement 10 in accordance with the present invention is illustrated in FIG. 1. The fluid filter arrangement 10 includes a housing 12 taking the form of a canister, a housing lid 14, a bypass valve 16 on an axially extending standpipe 22 and a filter cartridge 18. The housing lid 14 threadedly connects to the housing 12 to define an interior cavity 20 therebetween. The standpipe 22 extends vertically upwards from the housing 12 and into the interior cavity 20. The standpipe 22 includes the bypass valve 16 therein. The filter cartridge 18 is removably secured to the housing lid 14 and located within the interior cavity 20. In an assembled condition, the filter cartridge 18 surrounds the standpipe 22.

The housing 12 defines an inlet 26 and an outlet 28 to the cavity 20. When the fluid filter arrangement 10 is assembled, the filter cartridge 18 is inserted into the cavity 20, the inlet 26 is in fluid communication with the exterior of the filter cartridge 18 and the outlet 28 is in fluid communication with the interior of the cartridge 18. Specifically, the outlet 28 is in fluid communication with the interior of the cartridge 18 through a plurality of ports 32 in the standpipe 22 which when assembled is positioned within the interior of the filter cartridge 18.

The filter cartridge 18 includes a ring of filter media 36. The filter media 36 defines an interior volume which can be filled in part with a tubular support if desired for radial support of the filter media (not shown) or left empty. In any event, the interior volume of the filter media 36 provides sufficient clearance to receive the standpipe 22. Bottom and top end caps 38, 40 are sealingly bonded to first and second ends 42, 44 of the filter media 36 and further define the interior of the filter cartridge 18. The end caps 38, 40 are preferably plastic and sealingly bonded to the ring of filter media 36 by a potting material 46 such as plastisol. However, the end caps 38, 40 may be made from other suitable materials such as metal. Specifically, the ring of filter media 36 is received in annular wells 47 defined by walls axially extending from the interior sides of the end caps 38, 40. Other seal bonding techniques may be used and include plastic welding techniques or other such bonding means so as to prevent short circuiting of fluid between the filter media and the end cap.

The bottom end cap 38 defines a first opening 48 fluidly communicating with the interior of the filter cartridge 18. It will be appreciated that the interior of the filter cartridge 18 is defined generally between the bottom and top caps 38, 40 and the interior of the ring of filter media 36. The bottom end cap 38 is a composite end cap comprising an endplate and an annular gasket 50 that defines and surrounds the first opening 48. The gasket 50 creates a seal between the bottom end cap 38 and the housing 12 when the filter cartridge 18 is inserted over the standpipe 22. Particularly, the gasket 50 provides a radial seal between the outer surface 52 of a base portion 54 from which the standpipe 22 extends. It will be appreciated that the gasket 50 could be any material that prevents fluid from short-circuiting the filter cartridge 18, preferably it is a rubber material (which is meant to include natural and/or synthetic materials and/or other rubberlike resilient materials), but may also comprise a felt type gasket (or other suitable seal material) mounted to the end cap as disclosed for example in the aforementioned Ardes patent. The standpipe 22 extends into the interior of the filter cartridge 18 via the first opening 48 and the hole in the gasket 50.

The top end cap 40 includes a second opening 56 in fluid communication with the interior of the filter cartridge 18. In an embodiment, the second opening 56 has a smaller diameter than the first opening 48. The top end cap 40 includes a plurality of prongs 58 projecting vertically upwards and away from the interior of the filter cartridge 18. The prongs 58 are adapted to releasably connect the filter cartridge to the housing lid 14. The disclosed embodiment uses prongs 58. However, other means for securing the top end cap 40 to the housing lid 14 may be used. The prongs 58 surround the second opening 56 and are radially spaced apart defining gaps 60 between adjacent prongs 58, which allow fluid to communicate to the fluid bypass. If other means are used for securing the top end cap 40 to the housing lid 14, other means for allowing fluid to pass through the connection means will be provided.

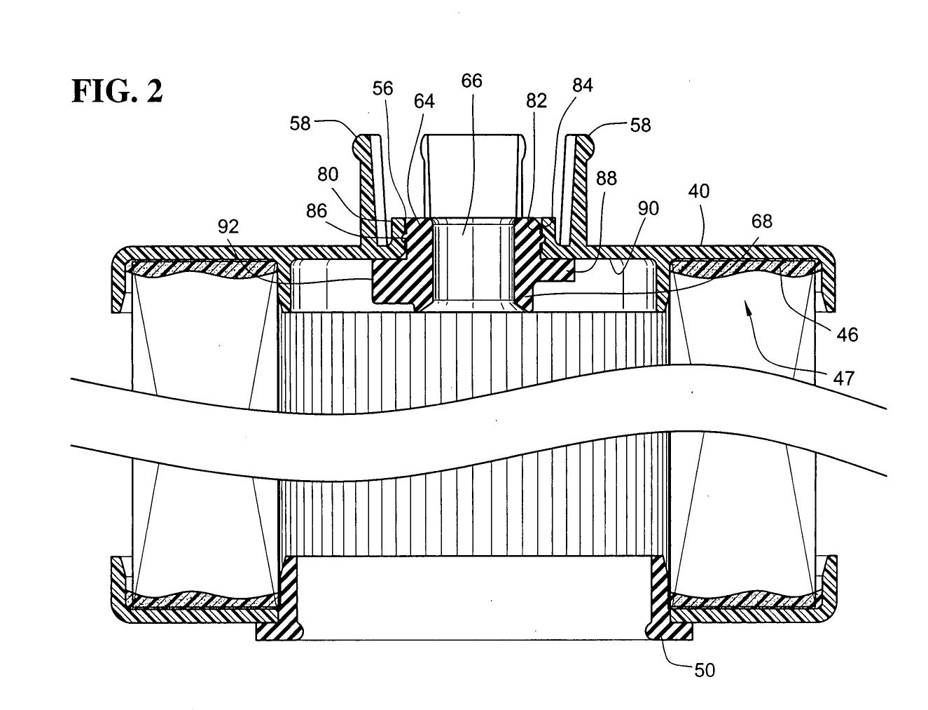

As best illustrated in FIG. 2, a grommet 64 separate from the end cap is configured to be received by the second opening 56. The grommet 64 is made from a sealing material, preferably a resilient sealing material and even more preferably a resilient rubber such that a seal is established between the grommet 64 and the top end cap 40. The grommet material is preferably softer, more deflectable and/or more compressible than the plastic end cap. The grommet 64 includes a passage 66 providing fluid communication between the interior and exterior of the filter cartridge 18. Furthermore, the passage 66 is in fluid communication with dirty fluid entering the cavity 20 via the gaps 60 defined between the prongs 58. The grommet 64 further includes an axial annular flange 68 that depends axially downward and includes a valve seat. In this embodiment, the axial annular flange 68 has a chamfered end to provide a valve seat 69 between the grommet 64 and a domed surface 74 of a valve member 76 of the bypass valve 16 (see FIG. 1). However, the valve seat could be provided by other means than specifically by the annular flange 68.

By making the grommet of a different, more resilient or more compressible material such as rubber, a plastic-on-plastic seal is avoided at the valve seat 69. Instead, the valve seat 69 has a more yielding and forgiving characteristic providing for better sealing reliability. Thus, an advantage is gained by providing a separate seal component independent of the end cap to effect a valve seat and sealing against the valve on the standpipe.

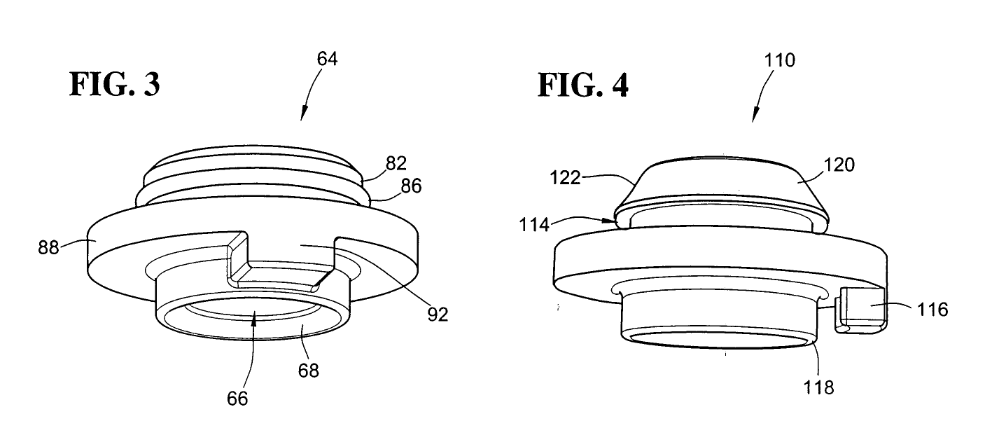

In this embodiment, the grommet 64 is removably installed within the second opening 56 by a friction fit between the grommet 64 and the top end cap 40. Specifically, the grommet 64 has a friction fit within an annular flange 80 that extends axially and vertically upward from the top end cap 40. The annular flange 80 defines the second opening 56. An outer surface 82 of the grommet 64 (see FIG. 3) frictionally engages an interior surface 84 of the annular flange 80 of the top end cap 40. The outer surface 82 of the grommet 64 further includes a radially projecting annular rib 86 that is compressed when the grommet 64 is inserted into the second opening 56 to focus the friction fit engagement between the grommet 64 and the interior surface 84 of the annular flange 80. Alternatively, the outer surface 82 of the grommet 64 could include a plurality of radially projecting ribs that extend axially along the outer surface 82 to improve the engagement between the grommet and the annular flange 80.

The rubber grommet 64 further includes a radially extending annular flange 88 that abuts and engages an interior side 90 of the top end cap 40. By abutting with the interior side 90, the radial annular flange 88 prevents the grommet 64 from being pushed completely through the second opening 56 when the grommet 64 is loaded in a direction extending from the interior to the exterior of the filter cartridge 18, particularly during installation or when the axial annular flange 68 is seated on the valve member 76. In addition, the radial annular flange 88 can improve or independently act as the seal between the grommet 64 and the top end cap 40, using the force of the housing to compress axially for sealing.

The grommet 64 may include a key 92 that extends radially outward from the axial annular flange 68 and axially downward from the radial annular flange 88. The key 92 can be used to angularly align the filter cartridge 18 relative to a standpipe 22, and unlock a latch (not shown) if provided on the standpipe, such as shown for example in U.S. Pat. No. 6,554,139 to Maxwell et al.

As shown in FIG. 1, the standpipe 22 extends from and is secured to a base 54 of the housing 12. The standpipe 22 may be a metal, plastic or other rigid material. The standpipe 22 may be adhesively, threadedly or frictionally secured to the base 54. The standpipe 22 carries the filter bypass valve 16. The bypass valve 16 includes a mushroom shaped valve member 76 that includes a head 98 and a shaft 100 and is resiliently biased by a coil spring 96. The head 98 is dome shaped and defines a domed top surface 74 and a flat bottom surface 102. It is contemplated that the head 98 could be a flat disc without the domed surface 74. If the head 98 is in the form of a flat disc, the axial annular flange 68 and valve seat 69 of the grommet 64 would be more appropriately configured to seal to the flat disc. The shaft 100 is substantially cylindrical in shape and extends vertically, however, in other embodiments the shaft could form other shapes.

The coil spring 96 is carried by the shaft 100 and positioned axially between the head 98 and a support flange 104 attached to and radially extending inward from the standpipe 22. Particularly, one end of the coil spring 96 abuts the bottom surface 102 of the head 98 and the other end abuts a top side of a support flange 104 to resiliently bias the valve member 76 vertically upwards. The end of the shaft 100, opposite the end that is attached to the head 98, includes a plurality of fingers 106 that extend radially outward from the shaft 100 and selectively abut a bottom side of the support flange 104 to permanently connect the valve member 76 to the standpipe 22. Particularly, the portion of the shaft 100 that includes the fingers 106 may be resiliently biased radially inward such that during installation, the valve member 76 may be snap fit to the support flange 104 of the standpipe 22.

The filter arrangement 10 is assembled by securing the filter cartridge 18 to the housing lid 14 via the plurality of prongs 58 that extend vertically upward from the second end cap 40. The combination of the housing lid 14 and filter cartridge 18 is then positioned over the standpipe 22 such that the standpipe 22 is inserted into the interior of the filter cartridge 18 through the first opening 48 in the bottom end cap 38. Particularly, the standpipe 22 is inserted through the hole in the gasket 50 inserted into the first opening 48 of the bottom end cap 38. After the housing lid 14 bottoms out on the housing 12, the housing lid 14 is then screwed to the housing 12. As the housing lid 14 is screwed to the housing 12, the gasket 50 of the bottom end cap 38 seals against the outer surface 52 of the base 54 to prevent short-circuiting of fluid from the dirty side of the filter to the clean side of the filter.

Furthermore, as the housing lid is screwed to the housing 12, the grommet 64 seats with the valve member 76. Particularly, the beveled axial annular flange 68 and specifically the valve seat 69 seats on the domed surface 74 of the head 98. As the axial annular flange 68 seats to the head 98, the coil spring 96 may begin to compress vertically downward. It will be appreciated that the valve seat 69 on the axial annular flange 68 of the grommet 64 when the domed surface 74 of the head 98 creates a seal that prevents dirty fluid from short-circuiting the filter cartridge 18 through the top end cap 40.

In operation, the bypass valve 16 acts to selectively allow dirty fluid to short-circuit and flow through the filter cartridge 18 when the filter media 36 has become sufficiently plugged with filtered contaminants such that insufficient fluid may flow through the filter media 36. Particularly, as the filter media 36 becomes increasingly plugged with filtered contaminants, the pressure differential across the filter media 36 between the high pressure dirty fluid side and lower pressure clean fluid side increases.

At some predetermined pressure differential, the load created by the dirty fluid acting on the domed surface 74 of the head 98 will be greater than the load acting on the bottom surface 102 of the head 98 by the coil spring 96 and the clean fluid such that the valve member 76 will be actuated and move vertically downward. As the valve member 76 moves vertically downward, the axial annular flange 68 and the head 98 no longer contact, thereby opening the bypass valve 16, allowing dirty fluid to short circuit the filter cartridge 18. It will be appreciated, that the predetermined pressure differential at which the bypass valve 18 will open can be varied by providing coil springs 96 with different stiffnesses.

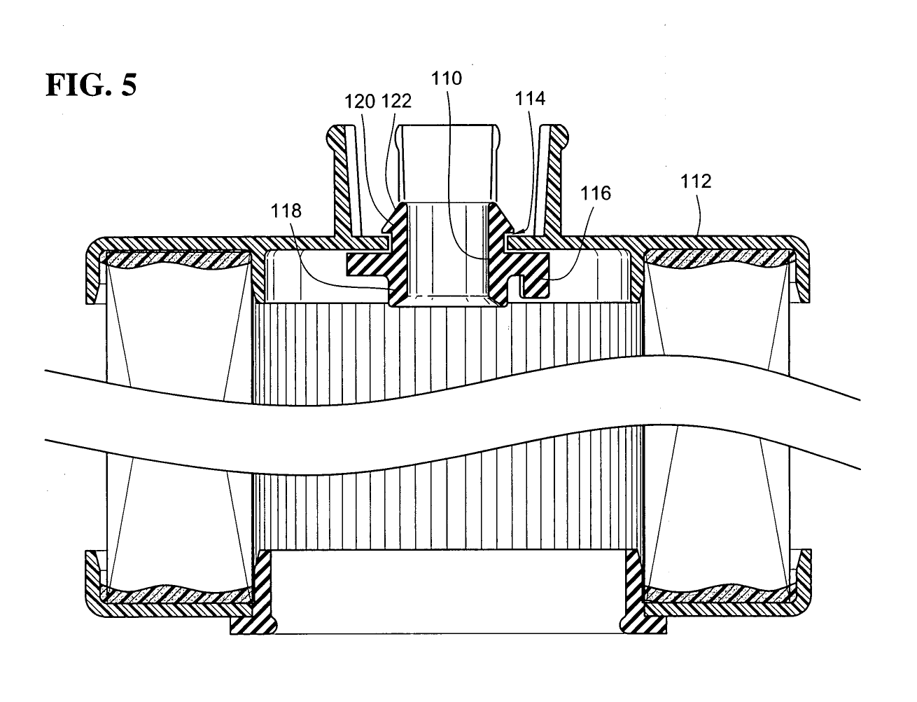

Another embodiment of a grommet in accordance with the present invention is illustrated in FIGS. 4 and 5. This grommet 110 is similar to the previous grommet 64. However, the grommet 110 does not rely on a friction fit between the grommet 110 and the top end cap 112 to secure the grommet 110 thereto. Instead this embodiment uses a snap fit. A portion of the end cap 112 that defines the opening of the top end cap 112 is received by an annular groove 114 of the grommet 110 to provide a snap fit between the grommet 110 and the top end cap 112. The grommet 110 further includes an axially downward depending key 116. However, in this embodiment, the key 116 is radially spaced apart from the axial annular flange 118. Furthermore, the grommet 110 includes a conically-shaped cone portion 120 vertically above the groove 114. The cone portion 120 includes a tapered surface 122 that assists insertion of the grommet 110 into the opening of the top end cap 112. An advantage of this embodiment can be that the grommet 110 may move radially slightly to accommodate slight misalignments between top and bottom end caps. The grommet 110 is urged axially against the top end cap by the housing when installed to prevent fluid leakage therebetween.

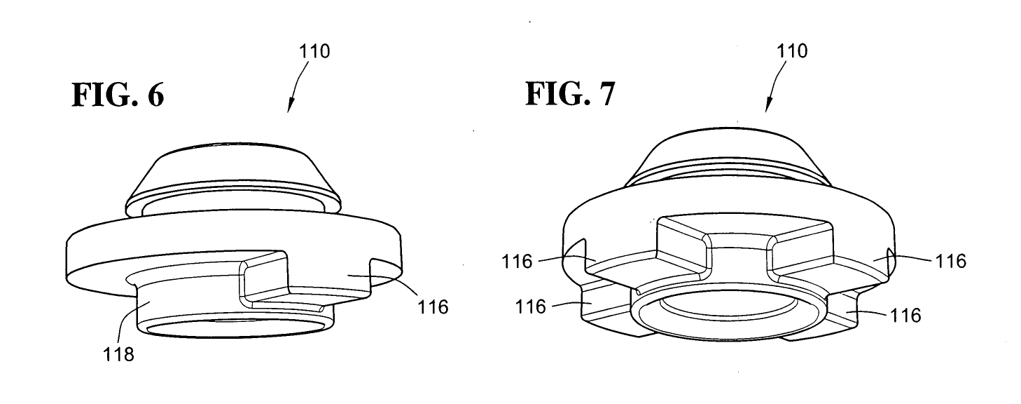

As shown in FIG. 6, another embodiment of the grommet 110 has the key 116 attached to and radially extending outward from the axial annular flange 118. Yet another embodiment of the grommet 110 is shown in FIG. 7 and includes a plurality of keys 116 integrally connected as a single projection but angularly spaced apart from one another. As illustrated, the grommet 110 includes four (4) keys 116, however, the invention is not limited to any specific number of keys 116. The keys are optional structures that can be used to unlock a latch when provided on a housing.

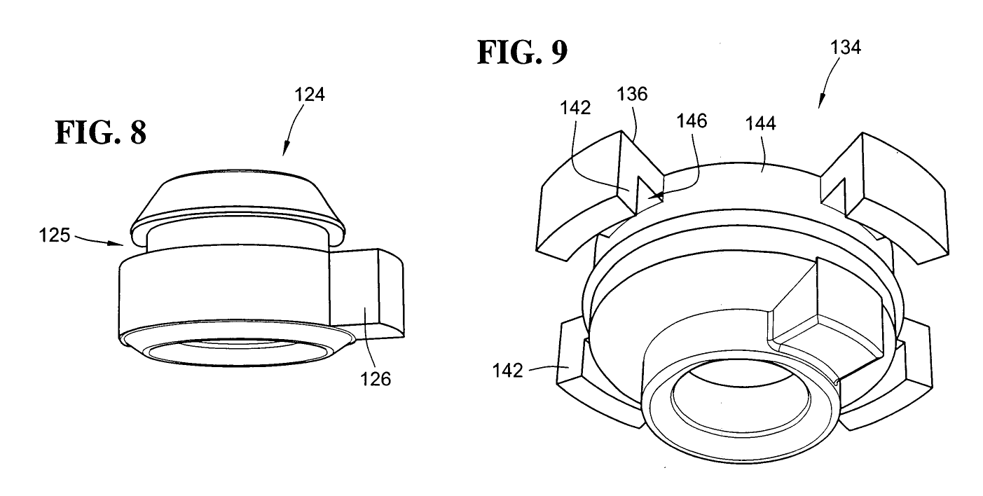

Another embodiment of the grommet is illustrated in FIG. 8. This embodiment is similar to the previous grommets. However, this grommet 124 does not include a radially extending annular flange like the previous embodiments. In this embodiment, the key 124 extends radially outward from the body of the grommet 124. When the grommet 124 is installed in an end cap, the key 126 functions to prevent the grommet 124 from being pushed all the way through the opening of the end cap. The grommet 124 seals against the top end cap radially by interference of the top end cap inner diameter and the outer diameter of the groove bottom in the grommet 124.

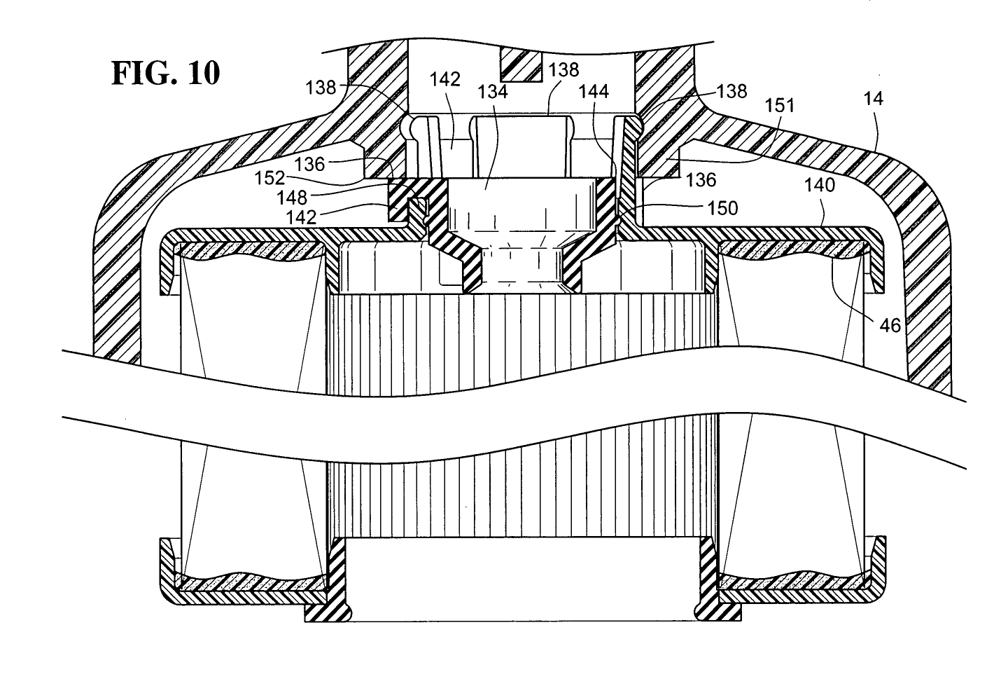

A further embodiment of a grommet in accordance with the present invention is illustrated in FIGS. 9 and 10. The grommet 134 in this embodiment includes a plurality of legs 136. The legs 136 are angularly spaced apart and extend radially outward from an outer surface 144 of the grommet 134. As shown in FIG. 10, the legs 136 are angularly spaced apart such that they may be interposed between the angularly spaced apart prongs 138 of the top end cap 140. Particularly, the legs 136 are interposed within the gaps 142 defined between adjacent prongs 138. Each leg 136 includes an axially downward depending portion 142 that is radially spaced from the generally cylindrical outer surface 144 of the body of the grommet 134 such that a channel 146 is defined therebetween. The channels 146 are configured for snug fit receipt of a wall portion 148 extending vertically upwards from the top end cap 140, as illustrated in FIG. 10. The outer surface 144 of the body of the grommet 134 includes an annular rib 150 that compresses when the grommet 134 is inserted into the opening of the top end cap 140 to further strengthen the engagement and improve the seal between the grommet 134 and the wall portion 148 of the top end cap 140. Furthermore, the grommet 134 is axially secured to the top end cap 140 by an annular rim 151 of the housing lid 14 that extends vertically downward into the interior of the housing lid 14. Particularly, the legs 136 are positioned and secured between the bottom surface 152 of the annular rim 151 and the top of the vertically extending wall portions 148.

For clarity, annular as used herein is meant to include forming a ring, or otherwise ring shape including, but not limited to, circular, oval, rectangular, polygonal, or other shapes including a ring-like shape whether with flat or curved surfaces or a combination thereof.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fluid filter arrangement comprising:
a ring of filter media extending between first and second ends, the ring of filter media defining an interior;
a first end cap sealingly bonded to the first end of the filter media, the first end cap including a first opening fluidically connected with the interior;
a second end cap sealingly bonded to the second end of the filter media, the second end cap including a second opening and an inner edge surrounding the second opening;
a grommet comprising at least in part a sealing material different than said second end cap received by the second opening of the second end cap, the grommet being sealed against the second end cap, the grommet further including an annular flange including an annular valve seat and defining a fluid bypass opening.

2. The fluid filter arrangement of claim 1, wherein the grommet comprises a rubber material, the annular valve seat being made of the rubber material to provide sealing resiliency.

3. The fluid filter arrangement of claim 1, wherein the grommet defines a radial groove engaged with the inner edge of the second end cap.

4. The fluid filter arrangement of claim 3, wherein the grommet is resiliently snapped onto the second end cap, and wherein the grommet includes a radially projecting flange engaging an interior side of the second end cap.

5. The fluid filter arrangement of claim 4, wherein the grommet includes a cone portion, the radial groove disposed between the radially projecting flange and the cone portion, the cone portion defining a generally conical surface providing means for assisting in snapping the grommet into the second end cap.

6. The fluid filter arrangement of claim 1, wherein the second end cap includes a plurality of prongs projecting away from the ring of filter media, the prongs providing a housing connection means, and where the grommet includes a plurality of legs, each leg interposed between adjacent prongs and engaging an external face of the second end cap.

7. The fluid filter arrangement of claim 6, wherein at least one of the legs is positioned and configured to engage a housing for support thereby of the grommet against a valve on a standpipe when installed into the housing.

8. The fluid filter arrangement of claim 1, wherein the grommet includes a radially projecting flange engaging an interior side of the second end cap.

9. The fluid filter arrangement of claim 7, wherein the grommet includes a generally cylindrical surface press fit against the inner edge of the second end cap to releasably press fit the grommet to the second end cap.

10. The fluid filter arrangement of claim 9, wherein the generally cylindrical surface of the grommet includes an outer rib compressed in engagement with the inner edge of the second end cap.

11. The fluid filter arrangement of claim 2, further comprising at least one key in the grommet to provide an unlocking means.

12. The fluid filter arrangement of claim 1, further comprising a plurality of prongs integral with the second end cap to provide snap on connection means.

13. The fluid filter arrangement of claim 1, wherein the fluid filter arrangement further includes:
a filter housing defining an inner cavity a standpipe projecting into the cavity, the standpipe having an end portion including a valve; and
wherein the standpipe is received through the first end cap and the standpipe extends into the interior of the filter media, and wherein the annular valve seat is in sealing engagement with the valve.

14. The fluid filter arrangement of claim 13, wherein the housing comprises a canister having a base end and an open end, and a lid removably secured to the open end, the lid comprising a snap connection means, and wherein the second end cap comprises a plurality of prongs projecting away from an external surface of the second end away from the ring of filter media, the prongs being removably snapped onto the lid via the snap connection means.

15. The fluid filter arrangement of claim 13, wherein the first end cap sealingly engages the standpipe.

16. The fluid filter arrangement of claim 15, wherein a seal is mounted to the first end cap to provide sealing engagement between the standpipe and the first end cap.

17. A fluid filter arrangement comprising:
a cylindrical ring of filter media extending between first and second ends, the ring of filter media defining an interior;
a first end cap sealingly bonded to the first end of the filter media, the first end cap including a first opening fluidically connected with the interior;
a seal structure disposed surrounding the first opening configured for engagement with a standpipe;
a second end cap sealingly bonded to the send end of the filter media, the second end cap including a second opening;
snap connection means for releasably securing the second end cap to a housing;
a grommet comprising at least in part a sealing material different than said second end cap disposed on the second end cap, the grommet further including:
(i) means for defining an annular valve seat; and
(ii) means for defining a fluid bypass.

18. The fluid filter arrangement of claim 17, wherein the snap connection means comprises snap structures, and wherein the snap structures are disposed on one or more prongs projecting from the second end cap away from the interior.

19. The fluid filter arrangement of claim 18, wherein of the first and second end caps define first and second annular wells, respectively, each of the first and second wells having plastisol therein bonding the first and second end caps to the first and second ends, respectively, the second end cap including radial disc portion projecting radially inward of the well, the radial disc portion terminating in an edge surrounding the second opening, and wherein the prongs project from the disc portion, and wherein second opening is smaller in dimension than the first opening and wherein the grommet seals against the disc portion.

20. The fluid filter arrangement of claim 17, wherein the first and second end caps comprise a plastic material, and wherein the grommet comprises a rubber material.
